(19) United States
(12) Patent Application Publication
(10) Pub. No.: US 2008/0180372 A1
(43) Pub. Date: Jul. 31, 2008

(54) Display device

(75) Inventors: Hyuk-jin Kim, Cheonan-si (KR); Kyung-wook Kim, Seoul (KR); Dong-wuuk Seo, Cheonan-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/011,963

(22) Filed: Jan. 29, 2008

(30) Foreign Application Priority Data
Jan. 30, 2007 (KR) 10-2007-0009362

(51) Int. Cl. G09G 3/36

(52) U.S. Cl. 345/87

(57) ABSTRACT

A display device which comprises a display region including a plurality of pixels includes: a first insulating substrate; a gate line unit which extends in a first direction on the first insulating substrate and comprises a first gate line and a second gate line; a data line which insulatingly crosses the gate line unit; a gate driving chip connected to the first gate line to apply a gate signal to the first gate line; and a shift register connected to the second gate line to apply a gate signal to the second gate line.

### CROSS-REFERENCE TO RELATED APPLICATIONS

This application claims the benefit of priority of Korean Patent Application No. 10-2007-0009362, filed on Jan. 30, 2007 in the Korean Intellectual Property Office, the disclosure of which is incorporated herein by reference.

### BACKGROUND OF INVENTION

1. Field of Invention

The present invention relates to a display device, more particularly, to a display device which includes gate drivers of different types.

2. Description of the Related Art

A liquid crystal display (LCD) device generally includes a display panel which has a plurality of gate wires and a plurality of data wires crossing the gate wires, a gate driver connected to the gate wires to apply gate signals thereto and a data driver to apply data signals synchronized with the gate signal.

Generally, gate drivers and data drivers are available in the form of integrated circuit chips. These chips are mounted, either on a flexible film connected to the display panel, or directly mounted on the display panel. Recently, the gate driver has been provided by using silicon thin film transistors formed directly on the display panel.

A display panel which includes an increased number of pixels with an increased number of gate wires has an increased manufacturing cost, partly because the number of gate driving chips increases according to the increased number of the gate wires.

Currently, gate drivers comprising thin film transistors of amorphous silicon or polysilicon are provided as a shift register formed on the display panel. The shift register includes a plurality of dependent stages and signal lines connected thereto. In this type of gate driver, one carry signal transmits to a chain of gate lines. Once a defect of the carry signal occurs, the defect may successively spread and affect video image on the display panel.

### SUMMARY OF THE INVENTION

Accordingly, an embodiment of the present invention provides a display device which includes two types of gate driver, a gate driving chip and a gate driver implemented as a shift register formed directly on a display panel to reduce the dependence on gate driving chips and to reduce the number of defects.

Additional embodiments of the present invention will be set forth in the description which follows. Other additional embodiments of the present invention will be obvious from the description, or may be learned by practice of the present invention.

The foregoing and other embodiments of the present invention can be achieved by providing a display device comprising: a first insulating substrate comprising a display region; a first gate line unit which extends in a first direction on the first insulating substrate and comprises a first gate line and a second gate line; a first data line formed on the insulating substrate and extending in a direction substantially perpendicular to the first direction; the data line crossing the first gate line unit and being insulated from the first gate line unit; a plurality of pixels disposed in the form of a rectangular matrix comprising rows of pixels parallel to the first gate line unit and columns of pixels parallel to the first data line; a gate driving chip connected to the first gate line to apply a gate signal to the first gate line; and a shift register formed on the insulating substrate, the shift register being connected to the second gate line to apply a gate signal to the second gate line.

According to an embodiment of the invention, the display device further comprises a data driver, the data driver being connected to the first data line, the data driver applying a data signal to the first data line, the polarity of the data signal being changed at regular intervals.

According to an embodiment of the invention, the display device further comprises a second gate line unit comprising a first gate line and a second gate line, and the shift register includes a plurality of stages including a first stage and a second stage wherein a gate on signal applied by the gate driving chip to the first gate line of the first gate line unit is applied to the first stage of the shift register as a carry signal and the first stage applies a gate on signal to the second gate line of the first gate line unit, and a gate on signal applied by the gate driving chip to the first gate line of the second gate line unit is applied to the second stage of the shift register as a carry signal and is applied to the first stage of the shift register as a reset signal.

According to an embodiment of the invention, the display region is disposed between the gate driving chip and the shift register.

According to an embodiment of the invention, the gate driving chip and the shift register are disposed along one side of the display region.

According to an embodiment of the invention, the amplitudes of the gate on signals are modified so that the amplitude of the gate on signal output by the gate driving chip to the first gate line is less than the amplitude of gate on signal output by the shift register to the second gate line.

According to an embodiment of the invention, the amplitudes and on-times of the gate on signals are modified so that the amplitude of the gate on signal output by the gate driving chip to the first gate line is approximately equal to the amplitude of the gate on signal output by the shift register to the second gate line, and the on-time of the gate on signal output by the gate driving chip is less than the on-time of the gate on signal output by the shift register.

According to an embodiment of the invention, the first data line applies data signals to a first pixel, the first pixel comprises: a first thin film transistor comprising a gate electrode, a source electrode and a drain electrode, the gate electrode being connected to the first gate line of the second gate line unit and the source electrode being connected to the first data line; a first pixel electrode connected to the drain electrode of the first thin film transistor; a second thin film transistor comprising a gate electrode, a source electrode and a drain electrode, the gate electrode of the second thin film transistor being connected to the second gate line of the first gate line unit and the source electrode of the second thin film transistor being connected to the data line; and a second pixel electrode being connected to the drain electrode of the second thin film transistor, the second pixel electrode being separated from the first pixel electrode.

According to an embodiment of the invention, a data signal of one polarity is applied to the first pixel electrode and a data signal of the opposite polarity is applied to the second pixel electrode.

According to an embodiment of the invention, the display device further comprises a third gate line unit comprising a first gate line and a second gate line, the first data line applies data signals to a second pixel disposed between the second gate line unit and the third gate line unit and the second pixel comprises: a second pixel electrode controlled by a second gate line of the second gate line unit; and a first pixel electrode controlled by a first gate line of the third gate line unit, the first and second pixels are arranged along the direction of the first data line and the polarities of signals applied to the first pixel are the opposite of the polarities of data signals applied to the second pixel and data signals of one polarity are applied to the first pixel electrode of the first pixel and to the second pixel electrode of the second pixel.

According to an embodiment of the invention, the first pixel electrode and the second pixel electrode of the first pixel and the first pixel electrode and the second pixel electrode of the second pixel are sub-pixels.

According to an embodiment of the invention, the second gate line unit is disposed between two sub-pixels and data signals of one polarity are applied to the two sub-pixels.

According to an embodiment of the invention, a first sub-pixel of the two sub-pixels is connected to the first gate line of the second gate line unit and a second sub-pixel of the two sub-pixels is connected to the second gate line of the second gate line unit.

According to an embodiment of the invention, the display device further comprises a second insulating substrate facing the first insulating substrate; and a liquid crystal layer disposed between the first insulating substrate and the second insulating substrate, wherein a cutting pattern is formed in at least one of the first pixel electrode and the second pixel electrode and the liquid crystal layer is in a vertically aligned mode.

According to an embodiment of the invention, a row of pixels disposed between the first gate line and the second gate line comprises a first pixel and a second pixel the second pixel being adjacent to the first pixel, the first pixel and the second pixel being connected to the first data line, and the first pixel being connected to the first gate line and the second pixel being connected to the second gate line.

According to an embodiment of the invention, the row of pixels comprises pairs of pixels, each pair of pixels comprising two adjacent pixels to which data signals of one polarity are applied and wherein data signals of a first polarity and data signals of a second polarity are alternately applied to pairs of pixels arranged along the row.

According to an embodiment of the invention, the first data line is disposed between the two adjacent pixels in a pair of pixels to which data signals of one polarity are applied.

According to an embodiment of the invention, the display device further comprises a second data line, the second data line being disposed adjacent to the first data line, and a pair of pixels to which data signals of one polarity are applied is disposed between the first data line and the second data line.

According to an embodiment of the invention, one of the pixels in the pair of pixels is connected to the second gate line and the other pixel in the pair of pixels is connected to the first gate line.

The foregoing and other embodiments of the present invention can be achieved by providing a display device comprising: a plurality of gate lines; a plurality of data lines, the data lines crossing the gate lines, the data lines being insulated from the gate lines; a plurality of pixels disposed in a matrix form defined by the gate lines and the data lines, the matrix comprising rows and columns of pixels; and a gate driving chip and a shift register which are connected alternately to the gate lines along the direction of the data lines, and the plurality of gate lines includes gate lines connected to pixels in which the polarity of a data signal is changed from a previous polarity and are connected to the gate driving chip, and wherein two adjacent columns of pixels comprise pairs of pixels, each pair of pixels comprising two adjacent pixels, on pixel from each of the two columns and data signals of two polarities are applied to the pairs of pixels, the polarity alternating along the direction of the data lines.

According to an embodiment of the invention, two gate lines are disposed between pixels to which are applied data signals of opposite polarities.

The foregoing and other embodiments of the present invention can be achieved by providing a display device comprising: a plurality of gate lines; a plurality of data lines, the data lines crossing the gate lines, the data lines being insulated from the first gate lines; a plurality of pixels disposed in a matrix form defined by the gate lines and the data lines, the matrix comprising rows of pixels and columns of pixels; and a gate driving chip and a shift register, the gate driving chip and the shift register being connected alternately to the gate lines along the direction of the data lines, wherein data signals of two polarities are alternately applied to every two adjacent pixels disposed along the direction of the gate lines.

According to an embodiment of the invention, two adjacent pixels, to which data signals of one polarity are applied, are connected to a data line, the data line being disposed between the two adjacent pixels.

According to an embodiment of the invention, two gate lines are disposed between adjacent rows of pixels and one of the two adjacent pixels is connected to one of two gate lines disposed above the two adjacent pixels, and the other of the two adjacent pixels is connected to one of two gate lines disposed below the two adjacent pixels.

According to an embodiment of the invention, the one of the two gate lines disposed above the two adjacent pixels is connected to the gate driving chip and receives a gate on signal from the gate driving chip, and the one of the two gate lines disposed below the two adjacent pixels is connected to the shift register and receives gate signals from the shift register.

According to an embodiment of the invention, the data lines comprise a first data line and a second data line the second data line being disposed adjacent to the first data line, wherein a pair of pixels comprising two pixels located side by side to which data signals of one polarity are applied is disposed between the first data line and the second data line.

According to an embodiment of the invention, two gate lines are disposed above the pair of pixels and two gate lines are disposed below the pair of pixels and one of the pixels in the pair of pixels is connected to one of the two gate lines disposed above the pair of pixels, and the other pixel in the pair of pixels is connected to one of the two gate lines disposed below the pair of pixels.

According to an embodiment of the invention, the one of the two gate lines disposed above the pair of pixels is connected to the shift register and receives a gate on signal from the shift register, and the one of the two gate lines disposed below the pair of pixels is connected to the gate driving chip and receives a gate on signal from the gate driving chip.

### BRIEF DESCRIPTION OF THE DRAWINGS

The above and other embodiments of the present invention will become apparent and more readily appreciated from the following description of the exemplary embodiments, taken in conjunction with the accompanying drawings, in which:

FIG. 1 is a schematic view of a display device according to a first exemplary embodiment of the present invention;

FIG. 2 is a timing diagram showing the timing of gate on signals in the display device according to the first exemplary embodiment of the present invention;

FIG. 3 is a timing diagram showing the timing and amplitude of modified gate on signals in the display device according to the first exemplary embodiment of the present invention;

FIG. 4 is a timing diagram showing the timing and amplitude of modified gate on signals in the display device according to the first exemplary embodiment;

FIGS. 5A and 5B illustrate a dot inversion of the display device according to the first exemplary embodiment of the present invention;

FIG. 6 is a plan view of a display device according to a second exemplary embodiment of the present invention;

FIG. 7 is a cross-sectional view taken along line VII-VII in FIG. 6;

FIG. 8 is a schematic view of a display device according to a third exemplary embodiment of the present invention; and

FIG. 9 is a schematic view of a display device according to a fourth exemplary embodiment of the present invention.

### DETAILED DESCRIPTION OF EXEMPLARY EMBODIMENTS OF THE INVENTION

Descriptions will now be given in detail of the embodiments of the present invention, examples of which are illustrated in the accompanying drawings, wherein like reference numerals refer to like elements throughout. The embodiments are described below with reference to the figures so as to explain the present invention.

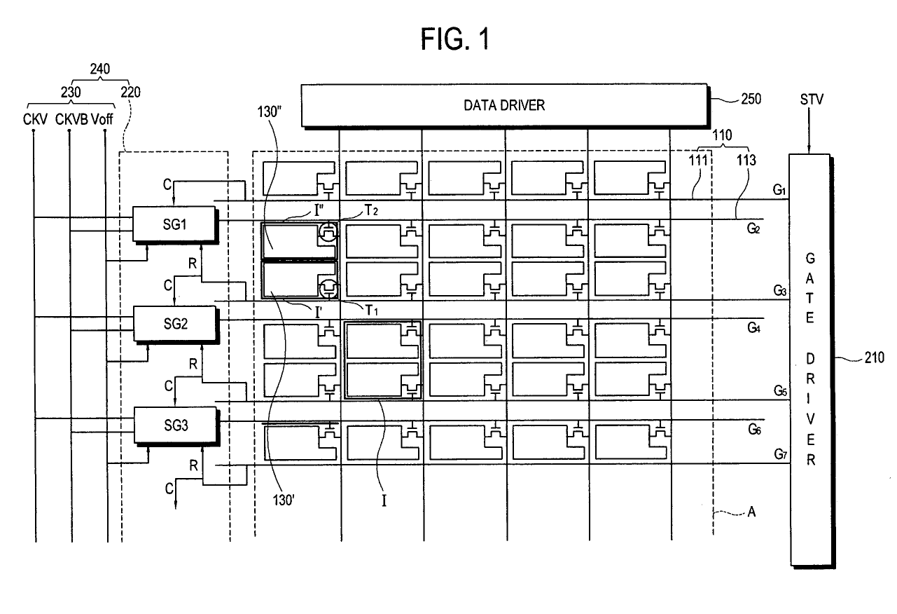

Referring to FIG. 1, a display device according to a first exemplary embodiment includes a display panel. The display panel includes an insulating substrate including a display region A. The display region A includes a plurality of pixels I. A gate driver chip 210 and a shift register gate driver 240 provide gate signals to the pixels I. A data driver 250 provides data signals to the pixels I.

A plurality of gate line units 110 extend in a first direction on the insulating substrate. A plurality of data lines 120 extend in a second direction on the insulating substrate and intersects the gate line unit 110. The location and size of pixels I is defined by the intersecting area of the gate line units 110 and the data lines 120 in the display region A. The pixels are arranged in the form of a matrix including rows of pixels and columns of pixels.

The gate line units 110 are disposed between neighboring rows of pixels. Each gate line unit includes a first gate line 111 and a second gate line 113 which is parallel to the first gate line 111. The data lines 120 cross the gate line units 110 and apply data signals to the pixels I. The data lines are insulated from the gate line units where they cross.

Each pixel I includes a first sub-pixel I′ connected to the first gate line 111 of a gate line unit located below the pixel and a second sub-pixel I″ connected to the second gate line 113 of a gate line unit located above the pixel. The sub-pixels I′ and I″ include thin film transistors T1 and T2 formed at an intersection area of the gate lines 111 and 113 and the data lines 120, and pixel electrodes 130′ and 130″ connected to the thin film transistors T1 and T2, respectively. The first sub-pixel I′ and the second sub-pixel I″ are connected to the same data line 120. The first sub-pixel I′ is connected to a thin film transistor T′ and the second sub-pixel I″ is connected to thin film transistor T2. The sub-pixels I′ and I″ are supplied with different data signals.

The gate drivers 210 and 240 include a gate driving chip 210 and a shift register 240. The shift register 240 includes amorphous silicon thin film transistors and are connected to the first gate lines 111. The gate driving chips are connected to the first gate lines 111. The gate drivers 210 and 240 apply gate signals including a gate on signal and a gate off signal to the first gate lines 111 and the second gate lines 113. The display region A is disposed between the gate driving chip 210 and the shift register 240. The gate driving chip 210 is disposed on the right side of the display region A, and the shift register 240 is formed on the left side of the display region A. Alternatively, the gate driving chip and the shift register may be located to one side of the display region A. The gate driving chip 210 may be mounted on a flexible film and connected to the display panel which has the display region A, or mounted directly on the display panel. The display device may further include a printed circuit board that applies various signals to the display panel.

The shift register 240 is not a gate driver on an integrated circuit chip but is a gate driver comprising thin film transistors formed in a non-display region of the display panel at the same time that the amorphous silicon thin film transistors are formed in the display region A. The thin film transistors in the shift register 240 may include amorphous silicon or polycrystalline silicon. The shift register 240 includes a plurality of stages 220, with each stage being connected to the first gate line and the second gate line 113 of a gate line unit 110, one stage to one gate line unit 110, and each stage 220 receiving a carry signal from the gate driving chip via the first gate line 111 of the gate line unit 110 and applying a gate on signal to the second gate line 113 of the gate line unit 110. Each stage is also connected to a plurality of signal lines 230 for applying various signals to the stages 220. The stages 220 include a plurality of thin film transistors (not shown). Each stage 220 outputs a gate on signal in response to a carry signal C and is initialized by a reset signal R. The signal lines 230 transmit a clock signal CKV, an inverse clock signal CKVB and the gate off signal Voff to the stages 220. In FIG. 1, the first gate lines 111 or odd-numbered gate lines of the gate lines 111 and 113 arranged along the direction of the data lines 120, i.e., the first gate line G1, the third gate line G3, the fifth gate line G5, and so on, are connected to the gate driving chip 210. The second gate lines 113, i.e., even-numbered gate lines including the second gate line G2, the fourth gate line G4, the sixth gate line G6, and so on, are connected to the shift register 240. The gate lines 111, that is to say, half of all the gate lines 111 and 113 are connected to the gate driving chip 210 and receive gate signals from the gate driving chip 210, and all of the gate lines are connected to the shift register 240 though only the gate lines 113 receive gate signals from the shift register 240. A vertical synchronizing start signal is applied to the gate driving chip 210 to apply the gate on signal to the first gate line G1.

As the size of the display device is increased, the gate lines 111 and 113 increase in number. In particular, when one pixel I includes two thin film transistors T1 and T2 as in the present exemplary embodiment, the number of gate driving chips needs to be increased as the number of the gate lines increases. As a result the manufacturing cost increases. Further, in the shift register in which the gate driver is formed directly on the display panel, the gate signal may ripple or its mobility may decrease due to a defective carry signal applied to the stages 220. Accordingly, a defective image may be formed on the display panel in addition to the gate signal being defective.

According to the present exemplary embodiment, as the gate lines 111 and 113 are alternately connected to the gate driving chip 210 and the shift register 240, the manufacturing cost, which is raised by increase of the number of gate driving chips 210, may be reduced and a defect due to the carry signal may be improved. That is, since the second gate lines 113 connected to the stages 220 are not connected to each other, the defect generated by a sequential carry signal may be prevented. In other words, as separate signals generated in the gate driving chip 210 are used to apply the carry signal and the reset signal to the stages 220, the signal is not transmitted between the second gate lines 113. Accordingly, when a defect is generated in the second gate lines 113 and the pixels I, it is not difficult to detect where the defect is generated and to repair the defect. Also, when the gate signal ripples, it is not transmitted to next gate line.

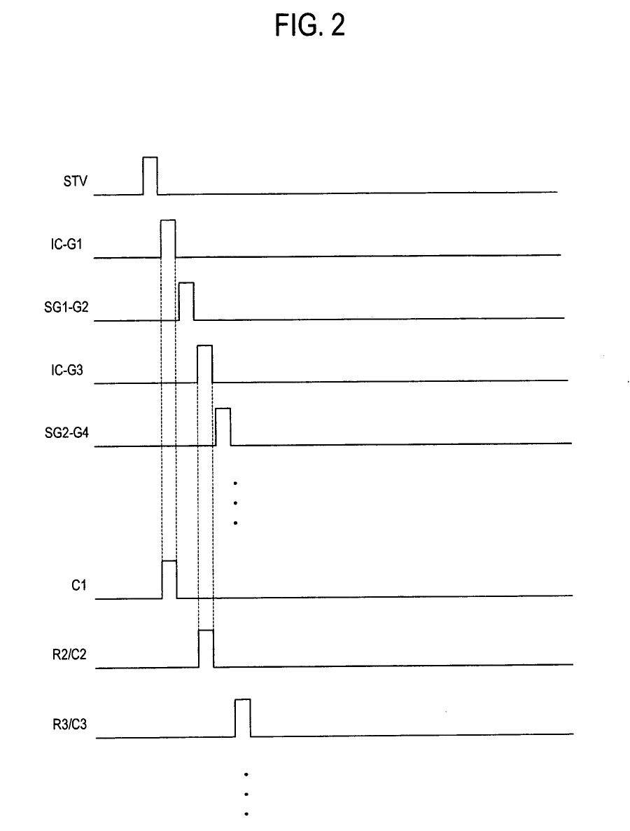

FIG. 2 illustrates the timing of gate on signals in the display device according to the present exemplary embodiment. First, when the vertical synchronizing start signal STV which indicates a start of one frame is applied to the gate driving chip 210, a gate on signal is applied to the first gate line G1 connected to the gate driving chip 210. One end of the first gate line G1 is connected to a control terminal of a first stage SG1. The gate on signal applied to the first gate line G1 is input to the first stage SG1 as a carry signal C1. A gate on signal is sequentially applied by the carry signal C1 to the second gate line G2 connected to the first stage SG1. One end of the third gate line G3 is connected to the gate driving chip 210, and the other end thereof is connected to the first stage SG1 and a predetermined control terminal of a second stage SG2. A gate on signal applied to the third gate line G3 is transmitted to the first stage SG1 and the second stage SG2. The gate on signal is input to the first stage SG1 as a reset signal R2 and to the second stage SG2 as a carry signal C2. A gate on signal is applied to the fourth gate line G4 by the carry signal C2 input to the second stage SG2. Likewise, a gate on signal applied to the fifth gate line G5 is input to the second stage SG2 as a reset signal R3 and to a third stage SG3 as a carry signal C3. Based on the relationship between the gate lines and the stages, first gate line G1 and second gate line G2 constitute a gate line unit, as do first gate line G3 and second gate line G4 and so on.

To sum up, a gate on signal output to the first gate line 111 of a second gate line unit 110 by the gate driving chip 210 is input to the second stage SG2, the second stage SG2 being connected to the second gate line 113 of the second gate line unit 110, as a carry signal and to the first stage SG1, connected to the second gate line 113 of a first gate line unit 110, as a reset signal. Likewise, a gate on signal is sequentially applied to the gate lines 111 and 113.

When the gate driving chip 210 and the shift register 240 are provided together as in the present exemplary embodiment, it is easy to conduct an inspection in a manufacturing process of the display device. There are ways to detect a defect in wires by applying a predetermined inspection signal to gate lines and data lines, wherein one way is to alternately apply an inspection signal to the gate lines. When the gate driver is provided only as the shift register, it is not possible to apply different inspection signals to odd-numbered gate lines and even-numbered gate lines, respectively. That is, since the stages are connected by the sequential carry signal and reset signal, it is impossible to apply the inspection signals separately to the gate lines to be divided into two groups.

In the present exemplary embodiment, however, it is possible to apply different inspection signals to the first gate line 111 connected to the gate driving chip 210 and the second gate line 113 connected to a stage 220. In this case, only a clock signal CKV is applied to the stages 220.

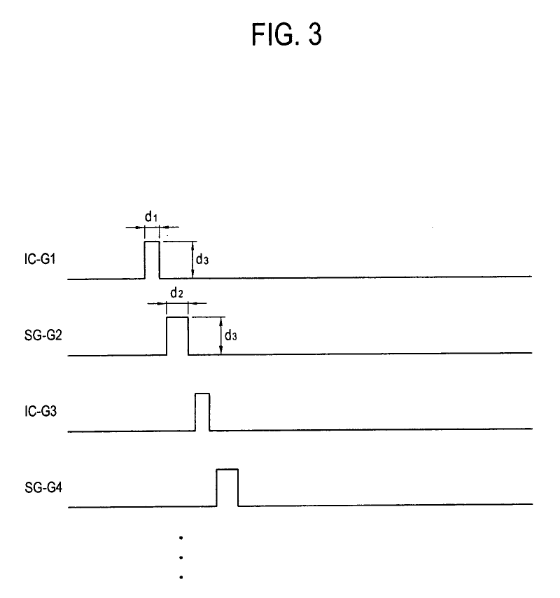

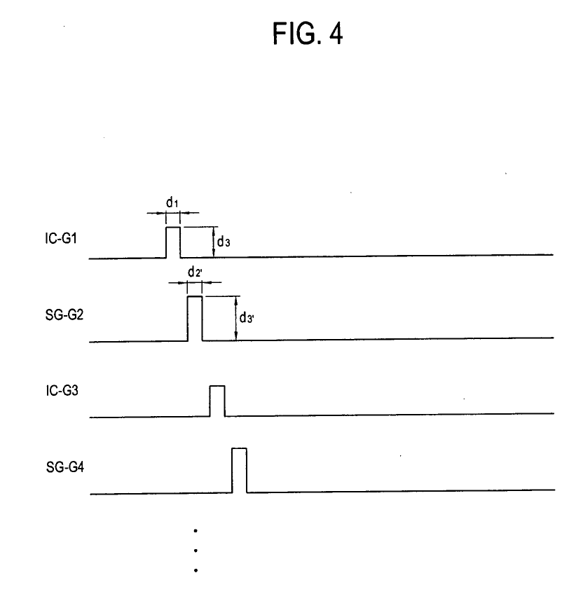

When the gate signal is applied from the gate driving chip 210 and the shift register 240, a gate on signal output from the shift register 240 is weaker than a gate on signal output from the gate driving chip 210, and thus the charging rate may vary between the pixels I. The gate on signal may be transformed to reduce the difference of the charging rate. FIGS. 3 and 4 are timing diagram showing the timing and amplitude of modified gate on signals. Gate on signals shown in FIG. 3 have different widths, and gate on signals shown in FIG. 4 have different amplitudes.

Referring to FIG. 3, a gate on signal applied to the gate lines G1, G3, etc. by the gate driving chip and a gate on signal applied to the gate lines G2, G4, etc. by the stages SG have approximately the same amplitude d3. However, the width d2 of the gate on signal applied by the stages SG is greater than the width d1 of the gate on signal applied by the gate driving chip 210 thereby compensating the insufficient charging rate. The width of the gate on signal, i.e., a time of applying the gate on signal or the on-time, may be changed by adjusting a gate on enable signal OE which regulates a width of a gate on signal.

FIG. 4 shows an alternative way of compensating the insufficient charging rate wherein the widths or on-times of the gate on signals are the same but the amplitudes are adjusted. The width d1 of a gate on signal supplied by the gate driving chip is the same as a width d2′ of a gate on signal supplied by the stages SG, but the amplitude d3 of the gate on signal from the gate driving chip is less than the amplitude d3′ of the gate on signal from the stage SG. The amplitude of a gate on signal is adjusted by changing the voltage level of the gate on signal.

The data driver 250 is referred to as a source driver. The data driver 250 receives various signals from an outside source, signals such as a horizontal synchronizing start signal STH for directing a start of inputting a gray scale signal, a load signal LOAD or TP for directing the application of a data signal to the data lines 120, an inverse control signal REV for changing the polarity of a data signal, and a data clock signal HCLK. The data driver 250 changes a transmitted image signal synchronized with a horizontal clock signal HCLK into a proper data signal using a gray scale voltage, and then outputs the data signal to the data lines 120 according to the load signal LOAD.

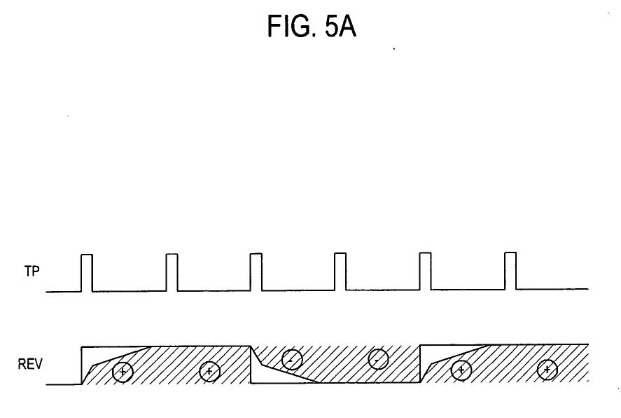

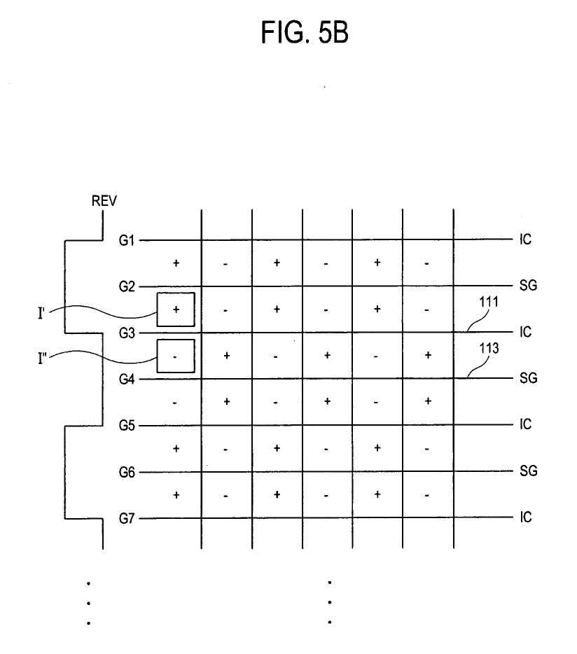

FIG. 5a illustrates the load signal TP and the inverse control signal REV, control signals that are input to the data driver 250. The data signal is applied to the sub-pixels I′ and I″ when the gate on signal is applied to the gate lines 111 and 113. The polarity of the data signal is changed after every two sub-pixels I′ and I″ by the inverse control signal REV, and thus the display device according to the present exemplary embodiment employs two-dot inversion where a polarity of a data signal is changed every two sub-pixels I′ and I″ by frame as shown in FIG. 5B. That is, data signals of two polarities are applied to every two adjacent sub-pixels I′ and I″ along the extending direction of the data lines 120. In other words, the polarity of the data signal is changed after every two sub-pixels I′ and I″. FIG. 5B shows a gate line between the sub-pixels I′ and I″ so as to help to explain the inversion. Referring to FIG. 1, pixels comprising two sub-pixels I′ and I″ are disposed between the gate line units 110, and the gate line unit 110 is disposed between sub-pixels I′ and I″ to which the same polarity of data signal is applied.

Referring to FIG. 5A, when the polarity of the data signal is changed from negative (−) to positive (+) or from positive (+) to negative (−), the voltage difference caused by the change of the data signal becomes high. It takes a predetermined time for the sub-pixels I′ and I″ to be completely charged with the data signal. A sub-pixel I′ where the polarity of a data signal is changed has a lower charging rate than a sub-pixel I″ where the polarity of a data signal is not changed. Thus, a gate line connected to the sub-pixel I′ where a polarity of a data signal is changed is connected to the gate driving chip 210 in order to compensate for decrease of the charging rate, as shown in FIG. 5B. In other words, the sub-pixel I′ to which is applied a data signal having an opposite polarity to a data signal applied to the former sub-pixels I′ and I″ is connected to the first gate line 111, and the sub-pixel I″ to which is applied a data signal having the same polarity as a data signal applied to the former sub-pixel I′ is connected to the second gate line 113. Thus, of the sub-pixels I′ and I″ which are adjacent in the extending direction of the data lines 120 and to which is applied a data signal with the same polarity, the former (above the gate line unit) sub-pixel I′ is connected to the first gate line 111, and the latter (below the gate line unit) sub-pixel I″ is connected to the second gate line 113. Namely, the display device according to the present exemplary embodiment adopts the two dot inversion to improve non-uniform charging rate generated by employing different gate drivers 210 and 240 and drives the sub-pixels I′ where a polarity of a data signal is changed using the first gate line 111 connected to the gate driving chip 210.

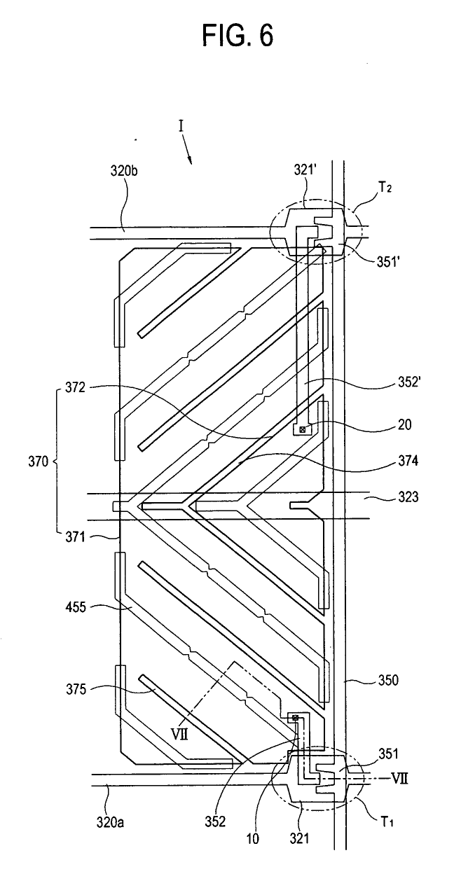

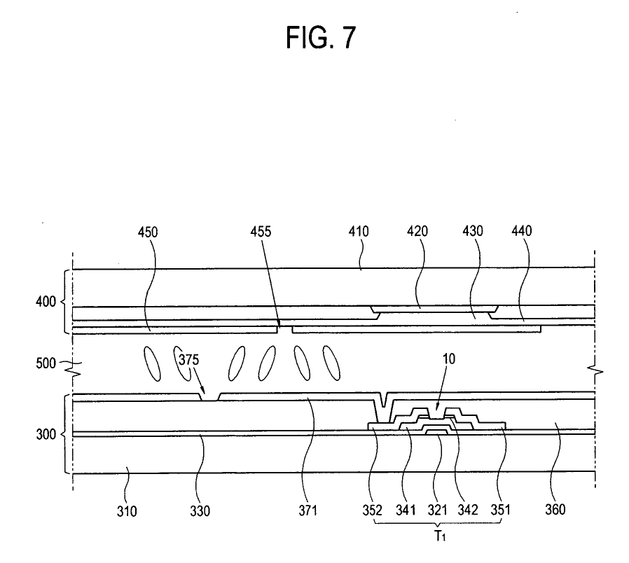

FIG. 6 is a plan view of a portion of a display device including a pixel according to a second exemplary embodiment of the present invention, and FIG. 7 is a cross-sectional view taken along line VII-VII. A pixel according to the present exemplary embodiment is illustrated as one example of the pixels in the first exemplary embodiment. A liquid crystal display (LCD) device is taken as an example of a display device. One rectangular pixel I includes two thin film transistors T1 and T2 and two pixel electrodes 371 and 372 connected to the thin film transistors T1 and T2, respectively. The display device includes a first gate line 320a and a second gate line 320b which each are arranged on the upper and lower sides of the pixel I along a first direction, and a data line 350 which extends along a second direction approximately perpendicular to the first direction.

A first substrate 300 will now be described.

The first substrate 300 includes an insulating substrate 310. A gate wiring layer is formed on the first insulating substrate 310. The gate wiring layer may be a metal single layer or may include metal multi-layers. The gate wiring includes gate lines 320a and 320b which extend transversely, gate electrodes 321 and 321′ connected to the gate lines 320a and 320b, respectively. and a storage electrode line 323 which overlaps with the pixel electrodes 371 and 372 to form a storage capacity. The storage electrode line 323 passes in the middle of the pixel and extends parallel with the gate lines 320a and 320b. The second gate line 320b extends adjacently to an upper short side of the pixel I and the first gate line 320a extends adjacently to a lower short side of the pixel I. The first gate electrode 321 extends from the first gate line 320a and the second gate electrode 321′ extends from the second gate line 320b.

A gate insulating layer 330 made of silicon nitride (SiNx) or the like is formed on the first insulating substrate 310 and covers the gate wiring.

A semiconductor layer 341 made of amorphous silicon or the like is formed on the gate insulating layer 330 over the gate electrodes 321 and 321′. An ohmic contact layer 342 highly doped with n-type impurities is formed in the semiconductor layer 341. The ohmic contact layer 342 is not formed in channel regions between source electrode 351 and the drain electrode 352 and between source electrode 351′ and drain electrode 352′.

A data wiring layer is formed on the gate insulating layer 330 and on the ohmic contact layer 342. The data wiring layer may be a metal single layer or may include metal multi-layers. The data wiring includes a data line 350 formed lengthwise to intersect the gate lines 320a and 320b, the source electrodes 351 and 351′ which are branched from the data line 350 and extend over the ohmic contact layer 342, and the drain electrodes 352 and 352′ formed on the ohmic contact layer 342 opposite to the source electrodes 351 and 351′, respectively. The first thin film transistor T1 comprises the first source electrode 351, the first drain electrode 352 and the first gate electrode 321. The first drain electrode 352 is connected to the first pixel electrode 371, the first source electrode 351 is connected to the data line 350 and the first gate electrode is connected to the first gate line 320a. The second thin film transistor T2 comprises the second source electrode 351′, the second drain electrode 352′ and the second gate electrode 321′. The second drain electrode 352′ is connected to the second pixel electrode 372, the second source electrode 351′ is connected to the data line 350 and the second gate electrode is connected to the second gate line 321′.

A passivation layer 360 is formed on the data wiring and on a portion of the semiconductor layer 341 which is not covered by the source electrodes 351 and 351′ and the drain electrodes 352 and 352′.

An organic layer may be formed on the passivation layer to increase a distance between the data line 350 and the pixel electrodes 371 and 372 to thereby minimize capacitance between the data line 350 and the pixel electrodes 371 and 372.

Contact holes 10 and 20 are formed in the passivation layer 360 to expose the first drain electrode 352 and the second drain electrode 352′, respectively. The pixel electrodes 371 and 372 are formed on the passivation layer 360. The pixel electrodes 371 and 372 are made of a transparent conductive material such as indium tin oxide (ITO) or indium zinc oxide (IZO).

The first pixel electrode 371 and the second pixel electrode 372 are separated by a pixel electrode separating pattern 374. The second pixel electrode 372 is triangle-shaped and it is surrounded on two of its three sides by the first pixel electrode 371. A pixel electrode cutting pattern 375 is formed in the first pixel electrode 371 and the second pixel electrode 372 parallel with the pixel electrode separating pattern 374. The pixel electrode separating pattern 374 and the pixel electrode cutting pattern 375 are symmetric on the storage electrode line 323 and incline to the gate lines 320a and 320b at about 45 degrees or 135 degrees.

The first pixel electrode 371 directly contacts the first drain electrode 352 through the contact hole 10, and the second pixel electrode 372 directly contacts the second drain electrode 352′ through the contact hole 20.

The pixel electrode separating pattern 374 and the pixel electrode cutting pattern 375 divide a liquid crystal layer 500 into a plurality of sub-domains along with a domain dividing pattern 455. Each sub-domain is an area surrounded by the patterns 374, 375 and 455. The sub-domains extend in a slant direction in the present exemplary embodiment.

The display device according to the present exemplary embodiment includes two thin film transistors T1 and T2 in each pixel I. A data signal having one voltage level is applied to the first pixel electrode and a data signal having a different voltage level is applied to the second pixel electrode, to improve visibility. When the same level of voltage is applied to the first and second pixel electrodes, transmittance of light varies from a lateral side to a front side, thereby decreasing visibility. In the present exemplary embodiment, however, light from a backlight unit (not shown) passes through the sub-domains, the liquid crystal layer 500 and a second substrate 400. In this embodiment, a normal data signal is applied to the first pixel electrode 371 and a somewhat weaker data signal is applied to the second pixel electrode 372, the data signal being little weaker than the data signal applied to the first pixel electrode 371 in order to adjust transmittance to be different for the pixel electrodes 371 and 372. Thus, in one pixel I there are applied different levels of voltages, and a difference in the gamma curves from the lateral side to the front side is decreased, thereby improving the visibility.

The second substrate 400 will now be described.

The second substrate 400 comprises a second insulating substrate 410. A black matrix 420 is formed on the second insulating substrate 410. The black matrix 420 is disposed between red, green and blue filters to divide the filters, and prevent light from impinging directly on the thin film transistors T disposed on the first insulating substrate 310. The black matrix 420 is typically made of an organic photoresist material into which a black pigment is added. The black pigment may be carbon black, titanium oxide or the like. The black matrix 420 may include a metal oxide such as chrome oxide.

A color filter layer 430 includes red, green and blue filters which are disposed in a repeating pattern and separated by the black matrix 420. The color filter layer 430 endows colors to light irradiated from the backlight unit (not shown) and passing through the liquid crystal layer 500. The color filter layer 430 is generally made of an organic photoresist material.

An overcoat layer 440 is formed on the black matrix 420 and the color filter layer 430. The overcoat layer 440 provides a flat surface and protects the color filter layer 430. The overcoat layer 440 is made of an acrylic epoxy material.

A common electrode 450 is formed on the overcoat layer 440. The common electrode 450 is made of a transparent conductive material such as indium tin oxide ITO or indium zinc oxide IZO. The common electrode 450 applies a common voltage directly to the liquid crystal layer 500 and, along with the pixel electrodes 371 and 372 on the first substrate 300, creates an electric field in the liquid crystal layer.

The domain dividing pattern 455 is formed in the common electrode 450. The domain dividing pattern 455 is formed parallel with the pixel electrode separating pattern 374 and the pixel electrode cutting pattern 375.

The foregoing patterns 374, 375 and 455 may be formed with various shapes.

The liquid crystal layer 500 is disposed between the first substrate 300 and the second substrate 400. The liquid crystal layer 500 is in a vertically aligned (VA) mode, where liquid crystal molecules are aligned perpendicular to the substrates 300 and 400 in a lengthwise direction between the substrates 300 and 400 under a voltage-off state. The liquid crystal molecules with negative dielectric anisotropy are oriented perpendicularly to an electric field in a voltage-on state.

Since the pixel I, to which are applied different levels of voltages, includes two thin film transistors to improve the visibility, an additional gate line is required to be formed. The first gate line 320a is connected to the gate of the first thin film transistor T1 and to a gate driving chip, and the second gate line 320b is connected to the gate of the second thin film transistor T2 and to the shift register. The thin film transistors T1 and T2 are controlled by the gate signals applied by the first gate line 320a and the second gate line 320b, respectively. A gate on signal applied to the first gate line 320a allows a data signal to be applied through the first thin film transistor to the first pixel electrode 371. Likewise a gate on signal applied to the second gate line 320b allows a data signal to be applied through the second thin film transistor T2 to the second pixel electrode 372.

Two dot inversion is employed in the present exemplary embodiment and in the first exemplary embodiment. A data signal of one polarity is applied to first pixel electrode 371 and a data signal of the other polarity is applied to the second pixel electrode 372 in one pixel I.

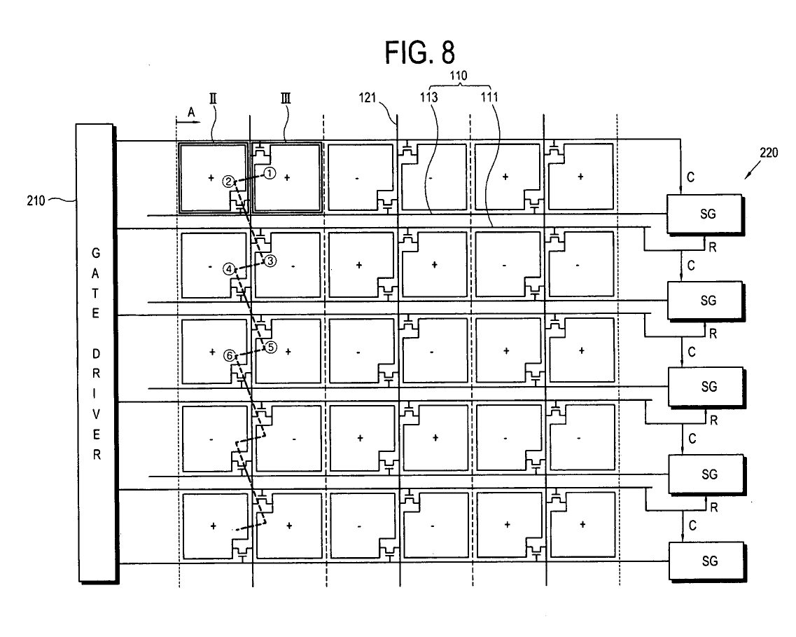

FIG. 8 is a schematic view of a display device according to a third exemplary embodiment of the present invention. FIG. 8 shows a substrate comprising a display region A and a peripheral portion of the substrate surrounding the display region A. In this display device, a gate driving chip 210, connected to first gate lines 111, is disposed on the peripheral portion of the substrate to the left of the display region A, and a shift register 240 comprising stages 220 connected to the first gate lines and to the second gate lines 113 is disposed on the peripheral portion of the substrate to the right of the display region A.

The pixels I are arranged in the form of a rectangular matrix comprising rows of pixels and column of pixels. Each row of pixels is disposed between the gate lines of a gate line unit 110, a first gate line 111 and a second gate line 113.

Two neighboring pixels II and III arranged in a row of pixels are connected to one data line 121. One of the pixels, pixel III is connected to the first gate line 111, and the other pixel, pixel II is connected to the second gate line 113. A gate on signal is sequentially applied to the gate lines 111 and 113, and a data signal transmitted through the data line 121 is applied first to the pixel III and then to the pixel II and likewise to two neighboring pixels in row after row as indicated in FIG. 8 by the sequence of numbered pixels (\textcircled{1}→\textcircled{2}→\textcircled{3}→\textcircled{4}→\textcircled{5}→\textcircled{6}). Thus, two neighboring columns of pixels are supplied with data signals by one data line 121.

In this display device, the number of the data lines 121 is half the number that would be required in a conventional display device, while the number of gate lines 111 and 113 is twice the conventional number. Thus, one half of the gate lines 111 and 113, that is the second gate lines 113, are connected to the stages 220 of a shift register formed on the display substrate in order to decrease the number of the gate driving chips 210 which should be increased as the gate lines 111 and 113 increase in number.

In the display device according to the present exemplary embodiment, which is different from that in the first exemplary embodiment, a data signal of one polarity is applied to two adjacent pixels II and III in one row of pixels and a data signal of the opposite polarity is applied to adjacent pixels II and III in the next row of pixels. The data signal of positive polarity in pixels \textcircled{1} and \textcircled{2}, is changed into a negative polarity in pixels \textcircled{2} and \textcircled{4}, and is changed again into a positive polarity in pixels \textcircled{5} and \textcircled{6}. In this case, to compensate for charging rate of data signals with different polarities, the pixel III in which a data signal is changed in polarity, disposed on the right side of the data line 121, is connected to the first gate line 111, and the pixel II in which a data signal is not changed in polarity, disposed on the left side of the data line 121, is connected to the second gate line 113. To speak generally, one of two pixels II and III supplied with a data signal of one polarity is connected to the first gate line 111 of a gate line unit 110, and the other pixel is connected to the second gate line 113 of the same gate line unit 110. The pixel III, in a first row of pixels, connected to the first gate line 111 of the gate line unit 110 has a different polarity from the former pixels II and III in a former row of pixels located immediately above the first row of pixels.

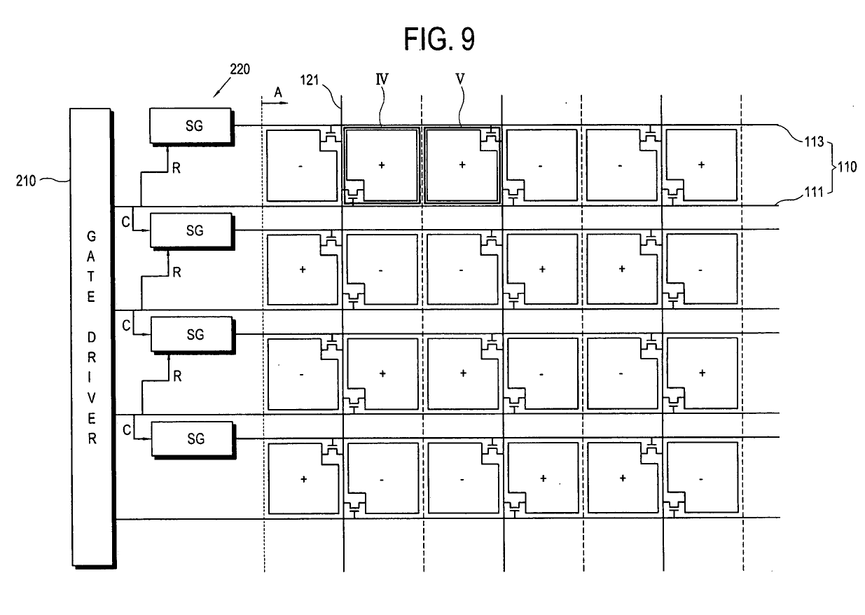

FIG. 9 is a schematic view of a display device according to a fourth exemplary embodiment of the present invention. In the present exemplary embodiment, a gate driving chip 210 and a shift register 240 comprising stages 220 are disposed on the peripheral area to one side of the display region A. As the driving chip 210 and the stages 220 are disposed on the same side of the display region A, gate lines 111 and 113 and signal lines (not shown) for carrying control signals to the stages 220 are formed of two different metal wiring layers, respectively.

In the present exemplary embodiment, the display device includes data lines 121 and gate line units 110 which are similar to those in the third exemplary embodiment. However, pixels IV and V to which are applied data signals of one polarity are not connected to the same data line 121, but are formed between two data lines 121, with pixel IV being connected to one data line 121 and pixel V being connected to the other data line 121. One of two pixels IV and V is connected to the first gate line 111 of a gate line unit 110, and the other pixel is connected to the second gate line 113 of the same gate line unit 110. With respect to the pixels connected to one data line 121 in FIG. 8, a polarity of a data signal changes every two pixels. In FIG. 9 the pixel IV where the polarity of a data signal is changed is connected to the first gate line 111. The pixel IV in a second row of pixels has a different polarity from the former pixels IV and V in a first row of pixels immediately above the second row of pixels.

In the present invention, gate lines are connected to different types of gate driver, thereby reducing manufacturing cost which would otherwise be raised by an increase in the number of gate driving chips and decreasing the defects generated by a shift register. Further, the present invention employs two dot inversion to decrease non-uniform charging rate which may be generated by including different types of gate driver.

As described above, the present invention provides a display device which includes fewer gate driving chips and in which a defect is decreased.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display device comprising:
a first insulating substrate comprising a display region;
a first gate line unit extending in a first direction on the first insulating substrate, the first gate line unit comprising a first gate line and a second gate line;
a first data line formed on the insulating substrate, the first data line intersecting the first gate line unit, and the first data line being insulated from the first gate line unit;
a plurality of pixels disposed in the form of a matrix comprising rows of pixels parallel to the first gate line unit and columns of pixels parallel to the first data line;
a gate driving chip connected to the first gate line to apply a gate signal to the first gate line; and
a shift register formed on the insulating substrate and connected to the second gate line to apply a gate signal to the second gate line.

2. The display device according to claim 1, further comprising a data driver, the data driver being connected to the first data line and applying a data signal to the first data line, the polarity of the data signal being changed at regular intervals.

3. The display device according to claim 1, further comprises a second gate line unit, the second gate line unit comprising a first gate line and a second gate line, and the shift register comprising a plurality stages including a first stage and a second stage, wherein a gate on signal applied by the gate driving chip to the first gate line of the first gate line unit is applied to the first stage of the shift register as a carry signal and the first stage applies a gate on signal to the second gate line of the first gate line unit, and a gate on signal applied by the gate driving chip to the first gate line of the second gate line unit is applied to the second stage of the shift register as a carry signal and applied to the first stage of the shift register as a reset signal.

4. The display device according to claim 1, wherein the display region is disposed between the gate driving chip and the shift register.

5. The display device according to claim 1, wherein the gate driving chip and the shift register are disposed along one side of the display region.

6. The display device according to claim 1, wherein the amplitudes of gate on signals are modified so that the amplitude of the gate on signal output by the gate driving chip to the first gate line is less than the amplitude of the gate on signal output by the shift register to the second gate line.

7. The display device according to claim 2 wherein the amplitude and on-time of gate on signals are modified so that the amplitude of the gate on signal output by the gate driving chip to the first gate line is approximately equal to the amplitude of gate on signal output by the shift register to the second gate line, and the on-time of the gate on signal output by the gate driving chip is less than the on-time of the gate on signal output by the shift register.

8. The display device according to claim 3, wherein the first data line applies data signals to a first pixel and the first pixel comprises:
a first thin film transistor comprising a gate electrode, a source electrode and a drain electrode, the gate electrode being connected to the first gate line of the second gate line unit and the source electrode being connected to the first data line;
a first pixel electrode connected to the drain electrode of the first thin film transistor;
a second thin film transistor comprising a gate electrode, a source electrode and a drain electrode, the gate electrode of the second thin film transistor being connected to the second gate line of the first gate line unit and the source electrode of the second thin film transistor being connected to the first data line; and
a second pixel electrode connected to the drain electrode of the second thin film transistor, the second pixel electrode being separated from the first pixel electrode.

9. The display device according to claim 8, wherein a data signal of one polarity is applied to the first pixel electrode and a data signal of the opposite polarity is applied the second pixel electrode.

10. The display device according to claim 8, further comprising a third gate line unit comprising a first gate line and a second gate line, the first data line applies data signals to a second pixel disposed between the second gate line unit and the third gate line unit and the second pixel comprises:
a second pixel electrode controlled by the second gate line of the second gate line unit; and
a first pixel electrode controlled by the first gate line of the third gate line unit,
and the first and second adjacent pixels are arranged along the direction of the first data line and the polarities of signals applied to the first pixel are the opposite of the polarities of data signals applied to the second pixel and data signals of one polarity are applied to the first pixel electrode of the first pixel and to the second pixel electrode of the second pixel.

11. The display device according to claim 10, wherein the first pixel electrode and the second pixel electrode of the first pixel and the first pixel electrode and the second pixel electrode of the second pixel area sub-pixels.

12. The display device according to claim 11, wherein the second gate line unit is disposed between two sub-pixels and data signals of one polarity are applied to the two sub-pixels.

13. The display device according to claim 12, wherein a first sub-pixel of the two sub-pixels is connected to the first gate line of the second gate line unit, and a second sub-pixel of the two sub-pixels is connected to the second gate line of the second gate line unit.

14. The display device according to claim 8, further comprising
a second insulating substrate facing the first insulating substrate; and
a liquid crystal layer disposed between the first insulating substrate and the second insulating substrate,
wherein a cutting pattern is formed in at least one of the first pixel electrode and the second pixel electrode and the liquid crystal layer is in a vertically aligned mode.

15. The display device according to claim 2, wherein a row of pixels disposed between the first gate line and the second gate line comprises a first pixel and a second pixel the second pixel being adjacent to the first pixel, the first pixel and the second pixel being connected to the first data line, the first pixel being connected to the first gate line and the second pixel being connected to the second gate line.

16. The display device according to claim 15, wherein the row of pixels comprises pairs of pixels, each pair of pixels comprising two adjacent pixels to which data signals of one polarity are applied, and wherein data signals of a first polarity and data signals of a second polarity are alternately applied to the pairs of pixels along the row.

17. The display device according to claim 15, wherein the first data line is disposed between the two adjacent pixels in a pair of pixels.

18. The display device according to claim 16, wherein the display device further comprises a second data line disposed adjacent to the first data line, and a pair of pixels to which data signals of one polarity are applied is disposed between the first data line and the second data line.

19. The display device according to claim 18, wherein one of the pixels in the pair of pixels is connected to the second gate line and the other pixel in the pair of pixels is connected to a first gate line.

20. A display device comprising:
a plurality of gate lines;
a plurality of data lines, the data lines crossing the gate lines and the data lines being insulated from the gate lines;
a plurality of pixels disposed in a matrix defined by the gate lines and the data lines, the matrix comprising rows of pixels and columns of pixels; and
a gate driving chip and a shift register which are connected alternately to the gate lines along the direction of the data lines,
and the plurality of gate lines includes gate lines connected to pixels in which the polarity of a data signal is changed from a previous polarity and connected to the gate driving chip, and wherein two adjacent columns of pixels comprise pairs of pixels, each pair of pixels comprising two adjacent pixels, one from each of the two columns and two polarities of data signals are applied to the pairs of pixels with the polarity alternating along the direction of the data lines.

21. The display device according to claim 20, wherein two gate lines are disposed between pixels, to which pixels are applied data signals of opposite polarities.

22. A display device comprising:
a plurality of gate lines;
a plurality of data lines, the data lines crossing the gate lines, the data lines being insulated from the gate lines;
a plurality of pixels disposed in a matrix form defined by the gate lines and the data lines, the matrix form comprising rows of pixels and columns of pixels; and
a gate driving chip and a shift register which are connected alternately to the gate lines along the direction of the data lines,
and data signals of a first polarity and data signals of a second polarity are alternately applied to every two adjacent pixels disposed along the direction of the gate lines.

23. The display device according to claim 22, wherein two adjacent pixels to which data signals of one polarity are applied are connected to a data line, the data line being disposed between the two adjacent pixels.

24. The display device according to claim 23, wherein two gate lines are disposed between adjacent rows of pixels, and one pixel of the two adjacent pixels is connected to one of two gate lines disposed above the two adjacent pixels, and the second pixel of the two adjacent pixels is connected to one of two gate lines disposed below the two adjacent pixels.

25. The display device according to claim 24, wherein the one of two gate lines disposed above the two adjacent pixels is connected to the gate driving chip and receives gate signals from the gate driving chip, and the one of the two gate lines disposed below the two adjacent pixels is connected to the shift register and receives gate signals from the shift register.

26. The display device according to claim 22, wherein the data lines comprise a first data line and a second data line the second data line being disposed adjacent to the first data line, wherein a pair of pixels comprising two pixels disposed side by side and supplied with the same polarity of data signal is disposed between the first data line and the second data line.

27. The display device according to claim 26, wherein two gate lines are disposed above the pair of pixels and two gate lines are disposed below the pair of pixels and one pixel of the pair of pixels is connected to one of the two gate lines disposed above the pair of pixels, and the other is connected to one of the two gate lines disposed below the pair of pixels.

28. The display device according to claim 27, wherein the one of the two gate lines disposed above the pair of electrodes is connected to the shift register and receives gate signals from the shift register, and the one of the two gate lines disposed below the pair of electrodes is connected to the gate driving chip and receives gate signals from the gate driving chip.
